(19) United States
(12) Patent Application Publication
(10) Pub. No.: US 2020/0325698 A1
(43) Pub. Date: Oct. 15, 2020

(54) Activity Pool

(71) Applicant: AF5, LLC, Lehi, UT (US)

(72) Inventor: Mark Allred, Lehi, UT (US)

(21) Appl. No.: 16/845,044

(22) Filed: Apr. 9, 2020

Related U.S. Application Data
(60) Provisional application No. 62/832,233, filed on Apr. 10, 2019.
(60) Provisional application No. 62/894,955, filed on Sep. 2, 2019.

(51) Int. Cl. E04H 4/14

(52) U.S. Cl. CPC E04H 4/14; E04H 4/0006

(57) ABSTRACT

Some embodiments include an activity pool comprising a pool volume having a top opening and a depth; and an activity deck disposed within the pool volume, the activity deck is moveable in a vertical direction between at least two configurations, the activity deck comprises a composite material; and a plurality of screw jacks coupled with the activity deck, the plurality of screw jacks move the activity deck between the at least two configurations, the plurality of screw jacks being coupled together with a one or more motor that engages each of the plurality of screw jacks via one or more worm gears.

### BACKGROUND

An activity pool can include a variety of different configurations. For example, the activity pool may be configured for water volleyball, stationary swimming, resistance training, surfing, standard swimming, or lounging. A wave generating apparatus can be used to provide a wave for recreational use, such as surfing, bodyboarding, or swimming in an activity pool. These apparatuses pump water from a reservoir over a channel to create the wave. More particularly, conventional apparatuses use a submersible axial flow pump to propel the water from the reservoir into the channel and over a vertical component with a sufficient speed to create a surfable surface of water.

### SUMMARY

Some embodiments include an activity pool comprising: a pool having a top opening and a depth; an activity deck disposed within the pool, the activity deck is moveable in a vertical direction between at least two configurations: and a plurality of lifts coupled with the activity deck, the plurality of lifts move the activity deck between the configurations. In some embodiments, the configurations may include: a full pool configuration where the activity deck is positioned at a first level, the first level being lowest vertical position; a sport pool configuration where the activity deck is positioned below the top opening of the pool at a second level, the second level being above the first level; a kiddie pool configuration where the activity deck is positioned below the top opening of the pool at a third level, the third level being above the first level and the second level; and an activity court configuration where the top surface of the activity deck is coplanar with or above the top surface of the pool;

In some embodiments, the activity deck comprises a composite material coupled with a metallic frame. In some embodiments, the second level is between 1 feet and 3 feet below the top surface of the pool. In some embodiments, the third level is between 4 inches and 3 feet below the top surface of the pool.

In some embodiments, the plurality of lifts comprise at least one lift selected from the group consisting of screw jacks, scissor lifts, hydraulic lifts, and cable and pulleys. In some embodiments, the plurality of lifts comprise a plurality of screw jacks. In some embodiments, the plurality of screw jacks are coupled with a one or more motor that engages each of the plurality of screw jacks to raise or lower the activity deck. In some embodiments, the plurality of screw jacks include a worm gear. In some embodiments, the plurality of screw jacks are disposed above a water line when the pool is filled with water. In some embodiments, the plurality of screw jacks are arranged in an H-shaped configuration or a U-shaped configuration.

In some embodiments, the activity pool may include an accessory mechanism removably coupled with a top surface of the activity deck.

Some embodiments include an activity pool comprising a pool volume having a top opening and a depth; and an activity deck disposed within the pool volume, the activity deck is moveable in a vertical direction between at least two configurations, the activity deck comprises a composite material; and a plurality of screw jacks coupled with the activity deck, the plurality of screw jacks move the activity deck between the at least two configurations, the plurality of screw jacks being coupled together with a one or more motor that engages each of the plurality of screw jacks via one or more worm gears.

In some embodiments, the plurality of screw jacks are coupled with a bottom of the activity deck.

In some embodiments, the at least two configurations are selected from the group consisting of: a full pool configuration where the activity deck is positioned at a first level, the first level being lowest vertical position; a sport pool configuration where the activity deck is positioned below the top opening of the pool at a second level, the second level being above the first level; a kiddie pool configuration where the activity deck is positioned below the top opening of the pool at a third level, the third level being above the first level and the second level; and an activity court configuration where the top surface of the activity deck is coplanar with or above the top surface of the pool.

In some embodiments the plurality of screw jacks are disposed above a water line when the pool is filled with water.

In some embodiments, the plurality of screw jacks are arranged in an H-shaped configuration or a U-shaped configuration.

In some embodiments, the activity deck comprises: a metallic frame; and a composite top surface.

In some embodiments, the activity deck includes a plurality of nut sleeves disposed within the activity deck.

Some embodiments may include an activity pool comprising a pool, an activity deck, a plurality of screw jacks, and an axial flow pump. In some embodiments, the pool may include an activity pool reservoir comprising a top opening and a depth; and a water reservoir comprising a depth greater than the usable pool depth. In some embodiments, the activity deck may be disposed within the activity pool reservoir. The activity deck may be moveable in a vertical direction between at least two configurations. The at least two configurations may include at least one of the following configurations: full pool configuration where the activity deck is in the lowest vertical position; a wave pool configuration where the activity deck is positioned below the top opening of the activity pool reservoir; and an activity court configuration where the top surface of the activity deck is coplanar with or above the top surface of the activity pool reservoir. In some embodiments, the plurality of screw jacks may be coupled with a bottom side of the activity deck. In some embodiments, the plurality of screw jacks may move the activity deck between the at least two configurations. In some embodiments, the axial flow pump is disposed within the water reservoir. In some embodiments, water from the water reservoir is forced through the axial flow pump and into the usable pool.

In some embodiments, the plurality of screw jacks are coupled with one or more motor that engages each of the plurality of screw jacks to raise or lower the activity deck. In some embodiments, the plurality of screw jacks include a worm gear. In some embodiments the plurality of screw jacks are arranged in an H-shaped configuration or a U-shaped configuration.

In some embodiments, the activity pool further comprises one or more accessory mechanisms that may be removably coupled with a top surface of the activity deck. In some embodiments, the accessory mechanism has a wedge shaped cross section. In some embodiments, the accessory has a triangular cross section. In some embodiments, the accessory mechanism comprises a wall. In some embodiments, the accessory mechanism comprises one or more posts for volleyball or basketball. In some embodiments, the accessory mechanism comprises a fin.

In some embodiments, the water reservoir has a bottom that is lower than a bottom of the activity pool reservoir.

In some embodiments the axial flow pump comprises a motor disposed above a water level in the water reservoir and near or at the top of the axial flow pump. In some embodiments, the axial flow pump comprises a motor disposed above the water level in the water reservoir and an intake that is disposed near the bottom of the water reservoir.

In some embodiments, the axial flow pump comprises: a water intake disposed near or at the bottom of the axial flow pump; a water flow channel fluidically connected with the water intake; a motor disposed above the water level and near or at the top of the axial flow pump; an impeller disposed at least partially between the water intake and the water flow channel; an impeller shaft coupled with the motor and the impeller, the impeller shaft extending from the motor to the impeller through the water flow channel; and an output disposed between the motor and the water flow channel, the output fluidically connected with the water flow channel and the usable pool.

In some embodiments, the activity pool includes a water return channel fluidically connected with the usable pool and the water reservoir.

Some embodiments include an activity pool comprising: a pool comprising: an activity pool reservoir comprising a top opening and a depth; and a water reservoir comprising a depth greater than the usable pool depth; an activity deck disposed within the activity pool reservoir, the activity deck is moveable in a vertical direction between at least two configurations; and an axial flow pump disposed within the water reservoir that forces water through the axial flow pump and into the usable pool. In some embodiments, the axial flow pump includes a water intake disposed near or at the bottom of the axial flow pump; a water flow channel fluidically connected with the water intake; a motor; an impeller disposed at least partially between the water intake and the water flow channel; an impeller shaft coupled with the motor and the impeller, the impeller shaft extending from the motor to the impeller though the water flow channel; and an output disposed between the motor and the water flow channel, the output fluidically connected with the water flow channel and the usable pool.

In some embodiments, the two configurations comprise at least one of the configurations selected from the list consisting of: a full pool configuration where the activity deck is in the lowest vertical position; a wave pool configuration where the activity deck is positioned below the top opening of the activity pool reservoir; and an activity court configuration where the top surface of the activity deck is coplanar with or above the top surface of the activity pool reservoir.

In some embodiments, the activity pool includes a plurality of screw jacks coupled with a bottom side of the activity deck, the plurality of screw jacks move the activity deck between the at least two configurations.

In some embodiments, the motor is disposed above the water level and near or at the top of the axial flow pump.

Some embodiments include an activity pool comprising: a pool comprising: an activity pool reservoir comprising a top opening and a depth; and a water reservoir comprising a depth greater than the usable pool depth; an activity deck disposed within the activity pool reservoir, the activity deck is moveable in a vertical direction between at least two configurations; a plurality of screw jacks coupled with a bottom side of the activity deck, the plurality of screw jacks move the activity deck between the at least two configurations, the plurality of screw jacks being coupled together with one or more motors that engages each of the plurality of screw jacks via a worm gear; and an axial flow pump disposed within the water reservoir that forces water through the axial flow pump and into the usable pool.

In some embodiments, the plurality of screw jacks are arranged in an H-shaped configuration or a U-shaped configuration.

This document describes activity pool components, systems, and methods of use and wave generating apparatuses and associated components, systems, and methods of use. In particular, this document describes a wave generating system that may include an axial flow pump that is not submersed in a water intake. The axial flow pump can increase efficiency and/or reduce costs compared to conventional systems using a conventional submersible pump. Some systems may include a nozzle for increasing pressure on water and/or improving uniformity in water flowing between the water intake and a channel. The nozzle may reduce turbulence and improve water columniation as it flows into the channel. The systems may also include a wave form to provide a disturbance of water flowing through the channel. Some wave forms may be modular, such that a wave is adjustable, or may be moveable or removeable within the channel. In this way, a user may customize a wave for the user.

In some embodiments, a wave machine includes a reservoir for storing water. The reservoir is in communication with an intake. An axial flow pump includes an impeller within the intake and a shaft that couples the impeller to a motor. The motor, positioned outside of the intake and the reservoir, drives the shaft to rotate the impeller to direct water through the intake from the reservoir to a nozzle. The motor may be vertically displaced from one or both of the intake and reservoir and/or horizontally displaced from one or both of the intake and reservoir. In some implementations, the motor, shaft, and impeller cooperate to vertically displace water from the reservoir to the nozzle. The nozzle directs the water from the nozzle into a channel. The channel includes one or more water returns that allows the water to return to the reservoir.

In some implementations, one or more of a height and a width of a portion of the nozzle proximate to the intake is greater than one or more of a corresponding height and width of another portion of the nozzle distal from the intake (e.g., proximate to the channel). The nozzle may have a variable cross-section. For example, the cross-sectional area may decrease in a direction from the intake to the channel. In some implementations, the nozzle includes a portion with a variable cross-section and another portion with a substantially uniform cross section.

The channel may be adjustable. For example, a portion or all of the channel may be vertically displaceable so that a depth of water above the channel may be adjustable. The channel may be adjustable so that it has a plurality of preconfigured heights at which the channel may be placed for various uses. For example, the channel may have a “maximum depth” preconfigured height at which the channel is configured for use as a swimming pool, a hot tub, or a current pool. The channel may have a “minimum depth” preconfigured height at which the amount of water above the channel is either shallow or negligible. Additionally, the channel may have at least one “intermediate depth” preconfigured height that is between the maximum depth and the minimum depth. For example, the intermediate depth may be used for surfing, for bodyboarding, or as a kid's pool.

The wave form may be adjustable. For example, the wave form may be movable along the channel to adjust a distance from the nozzle along a length of the channel.

Additionally or alternatively, the wave form may be adjustable along a width of the channel. Other ways in which the wave form can be adjusted include a slope of a face (surface nearest to the nozzle) of the wave form or an angle of the wave form with a side of the channel.

The axial flow pump may be adjustable to increase or decrease a flow rate of water out of the nozzle and into the channel. For example, a range of low flow rates may be used when the channel is configured as a current pool for swimming. Another range of flow rates may be used when the channel is configured for surfing or body boarding. In some implementations, the axial flow pump is configured to produce a flow rate based on one or more of a channel depth, an activity (swimming, body boarding, or surfing), and a configuration of a wave form. For example, the axial flow pump may be configured to produce a relatively high flow rate when surfing, and/or with an intermediate depth. The axial flow pump may be configured to produce a relatively high flow rate when the wave form is configured so that the face has a relatively steep slope.

The various embodiments described in the summary and this document are provided not to limit or define the disclosure or the scope of the claims.

### BRIEF DESCRIPTION OF THE FIGURES

FIG. 1 is an illustration of a perspective view of an activity pool according to some embodiments.

FIG. 2 is an illustration of a side view of an activity pool in a full configuration according to some embodiments.

FIG. 3 is an illustration of a side view of an activity pool in a wave pool configuration according to some embodiments.

FIG. 4 is an illustration of a side view of an activity pool in an activity court configuration according to some embodiments.

FIG. 5 is an illustration of a top view of an activity pool according to some embodiments.

FIG. 6 is a top view of the activity pool with the plurality of screw jacks arranged in an H-configuration beneath the activity deck according to some embodiments.

FIG. 7 is a top view of the activity pool with the plurality of screw jacks arranged in an U-configuration beneath the activity deck according to some embodiments.

FIG. 8 is a top view of the activity pool with the plurality of screw jacks arranged in an H-configuration on the side of the activity deck according to some embodiments.

FIG. 9 is a top view of the activity pool with the plurality of screw jacks arranged in an U-configuration on the side of the activity deck according to some embodiments.

FIG. 10 is a side view of an axial flow pump according to some embodiments.

FIG. 11 is an illustration of an example axial flow pump motor and impeller according to some embodiments.

FIG. 12 is an illustration of a guide vane structure disposed within the axial flow pump housing according to some embodiments.

FIG. 13 is an illustration of an outlet nozzle according to some embodiments.

FIG. 14 is a side view illustration of an activity pool along a slice through the activity pool according to some embodiments.

FIG. 15 is a top view illustration of an activity pool along a slice through the activity pool according to some embodiments.

FIG. 16 is a side view illustration of an activity pool in a sport pool configuration or a surf pool configuration according to some embodiments.

FIG. 17 is a top view illustration of an activity pool in a sport pool configuration or a swim pool configuration according to some embodiments.

FIG. 18 is a side view illustration of an activity pool in a sport pool configuration or a surf pool configuration according to some embodiments.

FIG. 19 is a top view illustration of an activity pool in a sport pool configuration or a surf pool configuration according to some embodiments.

### DETAILED DESCRIPTION

Some embodiments include an activity pool that can have a number of different functions or configurations. In some embodiments, an activity pool may include an axial flow pump that is not submersed within the water and can direct water from a reservoir, through an intake, and out an output nozzle. The output nozzle may further include a water pressurizer, which may increase pressure in the output nozzle, before directing the water into the channel. Some embodiments may include a detachable or removable wave form that can be disposed within an activity channel.

For example, water may be stored in a water reservoir. An axial flow pump may include an intake in communication with the water reservoir and houses an impeller and shaft coupled with a motor. The intake may include one or more guide vanes oriented generally parallel or off-axis relative to an axis of the intake. The guide vanes, for example, may be configured to reduce turbulence of water and/or water rotation as it flows through the intake. When the axial flow pump is active, the axial flow pump may direct water from the water reservoir, through the intake, and out the output nozzle. The output nozzle can expand laterally and/or vertically for a first distance from the intake and then contract laterally and/or vertically for a second distance from the first distance to a channel. In some embodiments, water may flow from the output nozzle into the activity channel. The water may approach a wave form in the channel, which disturbs a flow of the water such that the water forms a wave in the channel. The water flows through the channel to a return, which directs the water to the reservoir.

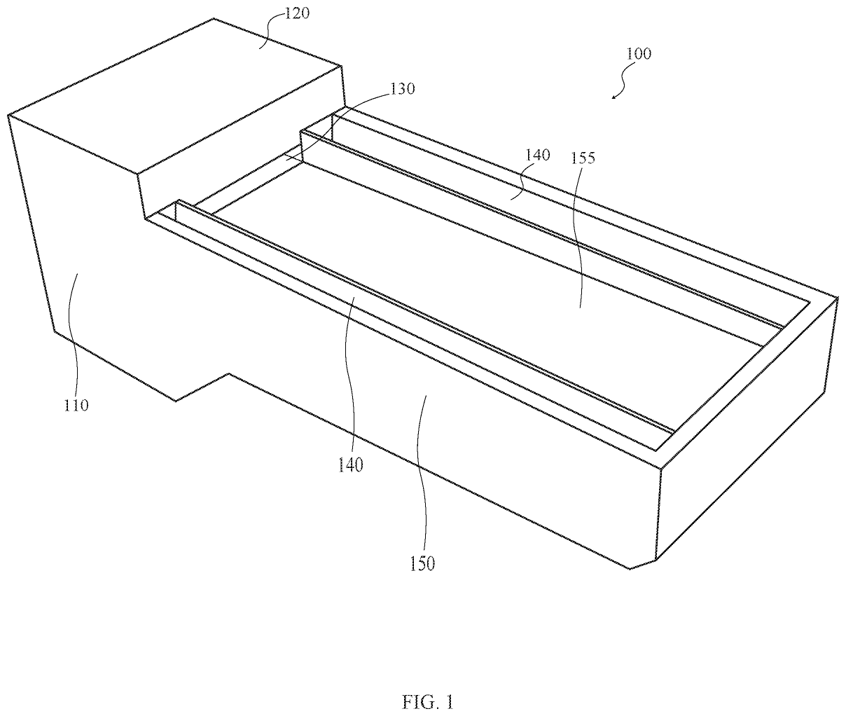

FIG. 1 is an illustration of a perspective view of an activity pool 100 according to some embodiments. The activity pool 100 may include a water reservoir 110, an axial flow pump housing 120, an outlet nozzle 130, one or more water return channels 140, and an activity pool reservoir 150. In some embodiments, water may be pumped from the water reservoir 110, through an intake in an axial flow pump 160 disposed within the axial flow pump housing 120, out the outlet nozzle 130 into an activity channel 155 of the activity pool reservoir 150. Water may return to the water reservoir 110 from the activity pool reservoir 150 via the one or more water return channels 140. In some embodiments, the axial flow pump 160 may pump water into the activity channel 155 of the activity pool reservoir 150 with a variable flow rate. In other words, the flow may be adjusted based on a user selected activity.

In some embodiments, the activity pool 100 may include one or more drain gates disposed between the activity pool reservoir 150 and the one or more water return channels 140. Water can flow from the activity pool reservoir 150 back to the water reservoir 110 via the water return channels 140.

In some embodiments, water return channels 140 may be disposed on one or both sides of the activity pool reservoir 150 and/or the back of the activity pool reservoir 150. The return channels 140 may be fluidically coupled with the water reservoir 110. Water can flow from the activity pool reservoir 150 back to the water reservoir 110 via the water return channels. In some embodiments, the water return channels 140 may include grates at the top surface of the water return channels 140. The grates, for example, may be made from fiberglass, ABS plastic, metal, composites, plastics, etc.

In some embodiments, the activity channel 155 may have longitudinal side walls that span a portion or all of the activity channel 155 from an end proximate to the outlet nozzle 130 to a distal end of the activity channel 155 opposite the outlet nozzle 130. The activity channel 155 may have an activity deck which can be adjusted to various heights to create various depths of water in the activity channel 155. The position of the activity deck may be described as a height (e.g., relative to a bottom surface of the activity pool reservoir 150) or a depth (e.g., relative to a water surface level within the activity pool reservoir 150). In some implementations, the activity channel 155 may have a bottom surface may have a sloped portion at or near the distal end of the activity channel 155.

The activity pool reservoir 110 may include an upper portion, a sloped portion and a lower portion. The bottom of the upper portion may be level with the bottom of the activity pool reservoir 150. This can, for example, guide water in the activity pool reservoir 110 toward the bell end 310 at the lower portion of the axial flow pump. In some embodiments, the activity pool reservoir 110 may be adjacent to the water return channel 140, rather than directly below the water return channel 140.

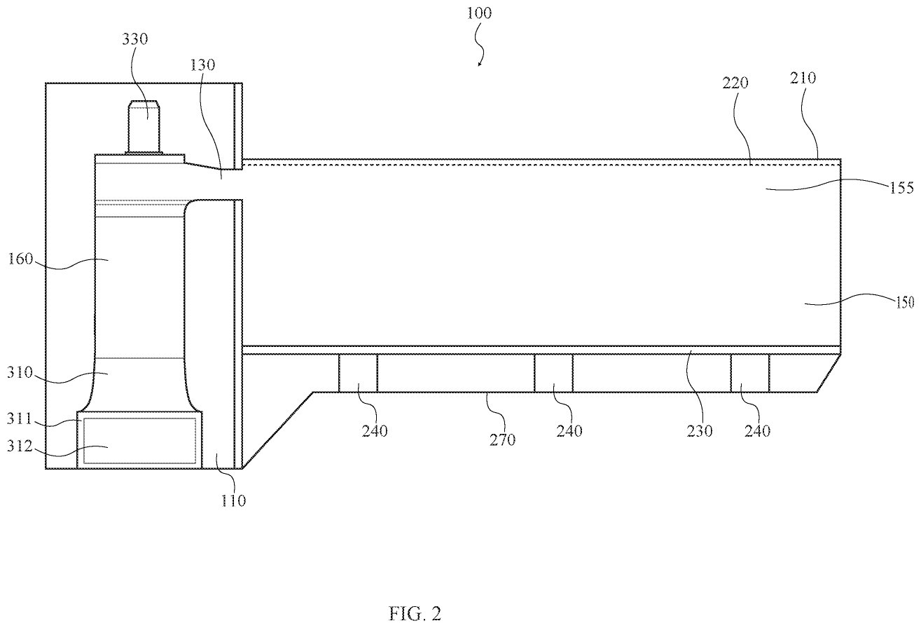

FIG. 2 is a side view illustration of an activity pool 100 along a slice down the middle of the activity pool 100 according to some embodiments. The activity deck 230 may adjust in height with a plurality of lifts 240 disposed between the bottom surface of the activity deck 230 and the bottom surface of the activity pool reservoir 150. The plurality of lifts 240 may include a system having one or more axles, acme screws, worm gears, and/or motors that are coupled together to raise and lower the activity deck 230. The plurality of lifts 240 may move the activity deck 230 between different heights to create different activity pool configurations.

FIG. 2 shows a side view of the activity pool 100 in a full pool configuration. In the full pool configuration, for example, the activity deck 230 may be disposed at or near the bottom of the activity pool reservoir 150. In the full pool configuration, for example, the plurality of lifts 240 may be at or near the lowest extended position of each of the plurality of lifts 240.

In some embodiments, the activity deck 230 may comprise a main structure comprised of a plurality of steel beams. In some embodiments, the activity deck 230 may comprise a surface having a plurality of slats or planks that may, for example, be disposed on the plurality of steel beams. In some embodiments, the activity deck 230 may comprise a plurality of composite members arranged side by side that may, for example, be disposed on the plurality of steel beams. In some embodiments, the activity deck 230 may comprise a plurality of Trex® decking material that may, for example, be disposed on the plurality of steel beams.

In some embodiments, the activity deck may include a plurality of nut sleeves. The plurality of nut sleeves, for example, may be welded into the activity deck 230. The accessory mechanisms may include bolts that can be screwed into the nut sleeves to attach the accessory mechanisms to the activity deck.

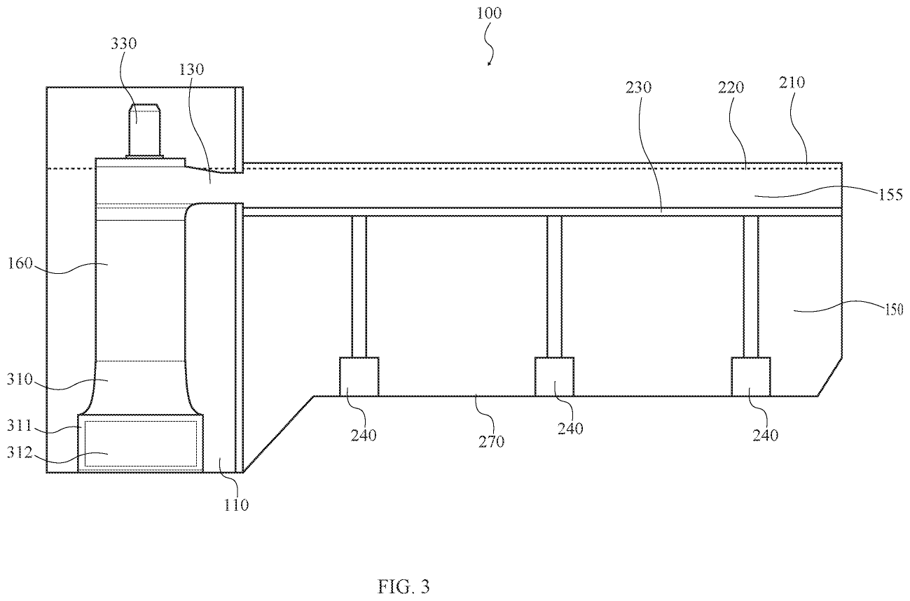

FIG. 3 shows a side view of the activity pool 100 in a wave pool configuration according to some embodiments. In the wave pool configuration, the activity deck 230 may be disposed at height below the water surface 220 such as, for example, at a height less than 2, 4, 6, 8, 12, 18 inches etc. below the water surface 220. In the wave pool configuration, the activity deck 230 may be disposed at height below the top surface 210 of the activity pool 100 such as, for example, at a height less than 2, 4, 6, 8, 12, 18 inches etc. below the top surface 210 of the activity pool 100. In some embodiments, the top surface 210 of the activity pool 100 may be level with the ground surrounding the activity pool 100.

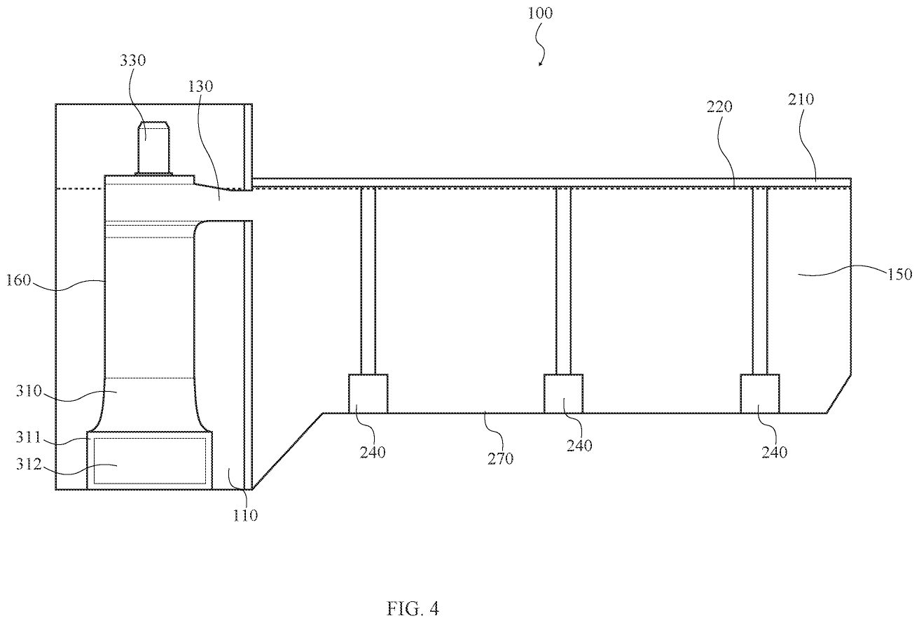

FIG. 4 shows a side view of the activity pool 100 in an activity court configuration according to some embodiments. In the activity court configuration, the activity deck 230 may be disposed at height such that the top surface of the activity deck 230 may be level with the top surface 210 of the activity pool 100 and/or level with the ground surrounding the activity pool 100. In the activity court configuration, the activity deck 230 may be disposed at a height above the water surface 220.

In some embodiments, the activity deck 230 may be adjusted or moved to into various other configurations. For example, the activity deck 230 may be moved into a swim configuration which places the activity deck 230 at a depth of about 3, 4, or 5 feet below the water surface 220.

In some embodiments, an activity pool may be in a kiddie pool configuration. In the kiddie pool configuration, for example, the activity deck may be positioned below the water level such as, for example, 4, 6, 8, 10, 12, 14, etc. inches below the water level. In the kiddie pool configuration, for example, the axial flow pump may be turned off or may not be included.

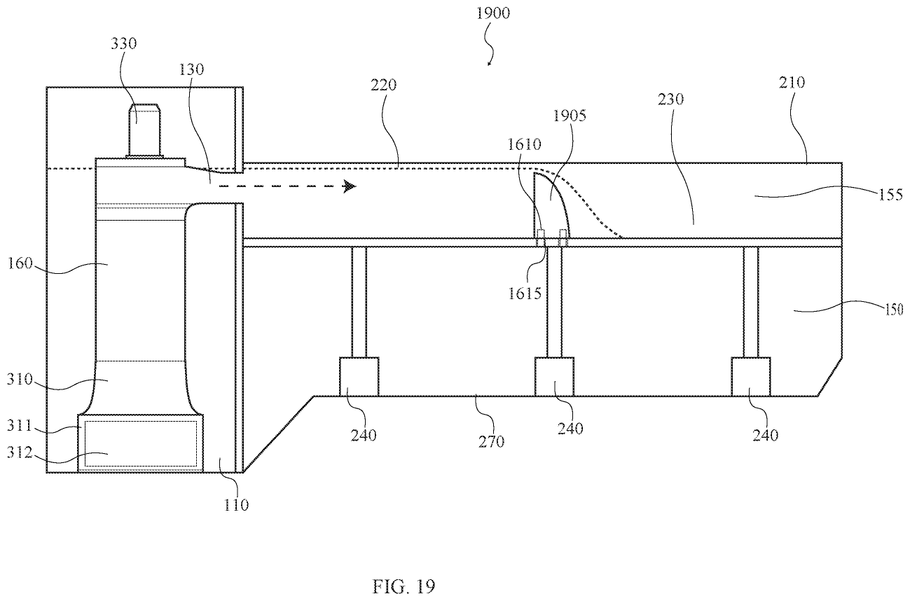

In some embodiments, an activity pool may be in a swimming configuration. In the swimming configuration, for example, the activity deck may be positioned below the water level such as, for example, 18, 24, 30, or 36, etc. inches below the water level. In the swimming configuration, for example, the axial flow pump may be turned on and/or a wall or fin shaped accessory may be attached with the activity deck such as, for example, as shown in FIG. 19.

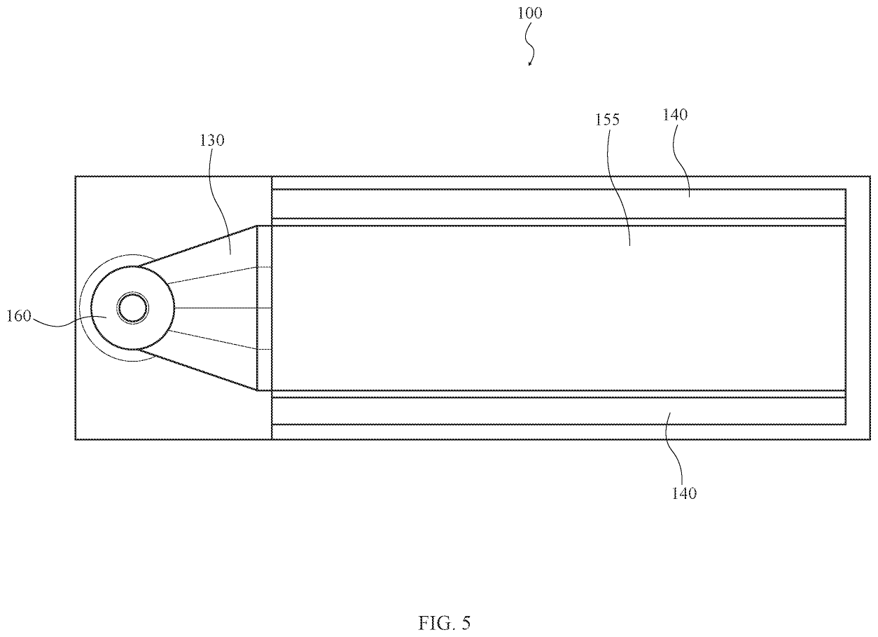

FIG. 5 is a top view of the activity pool 100 according to some embodiments.

In some embodiments, the plurality of lifts 240 may be arranged beneath the activity deck 230 in a U-Shape, H-Shape, or other shaped configurations. In some embodiments, the plurality of lifts are structurally attached with the activity deck 230 such as, for example, with the bottom of the activity deck 230 or with the sides of the activity deck 230. In some embodiments, one or more motor or one or more motors may be used to drive the plurality of lifts 240.

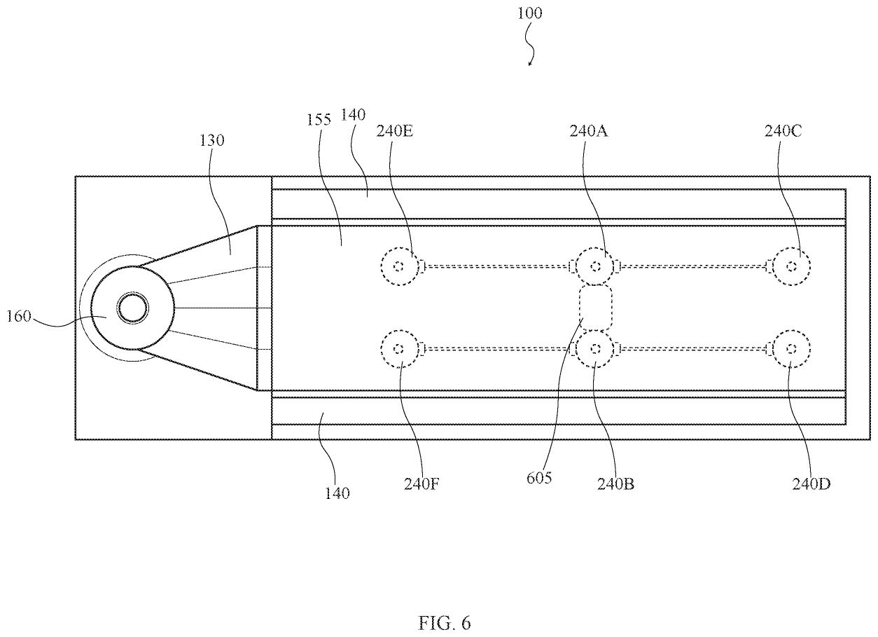

FIG. 6 is a top view of the activity pool 100 with the plurality of lifts 240 arranged in an H-configuration beneath the activity deck 230 according to some embodiments. In the H-configuration, the motor 605 may be coupled with lift 240A and 240B of the plurality of lifts 240 such as, for example, via a worm gear. The lift 240A may be coupled with lift 240C and lift 240E such as, for example, via two different worm gears. The lift 240B may be coupled with lift 240D and 240F such as, for example, via two different worm gears. In this example, the lifts 240A and 240B are arranged on opposites sides of the activity deck 230, the lifts 240F and 240E are arranged on opposites sides of the activity deck 230, and the lifts 240C and 240D are arranged on opposites sides of the activity deck 230.

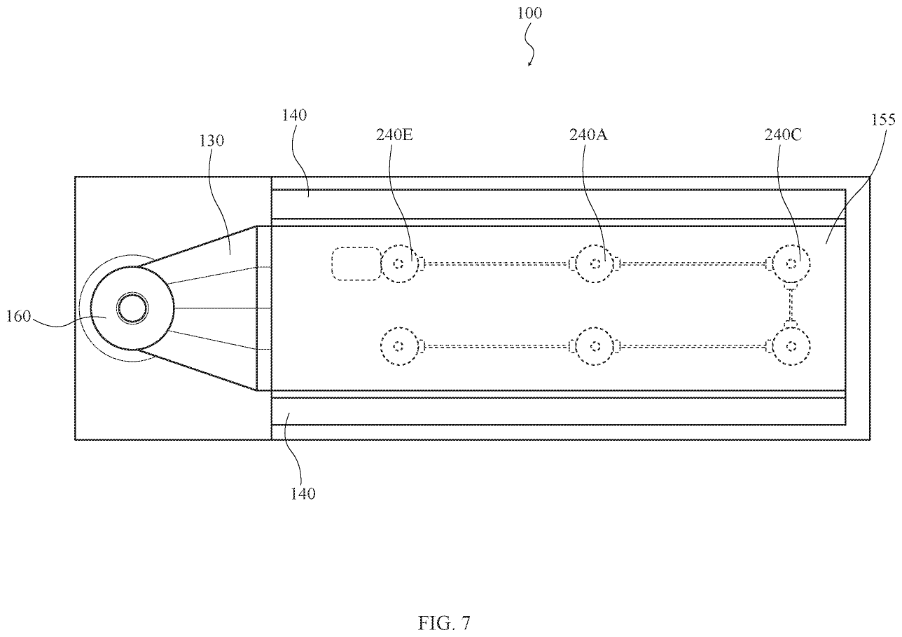

FIG. 7 is a top view of the activity pool 100 with the plurality of lifts 240 arranged in a U-configuration beneath the activity deck 230 according to some embodiments. In the U-configuration, the motor 605 may be coupled with lift 240E of the plurality of lifts 240 such as, for example, via a worm gear. The lift 240E may be coupled with lift 240A such as, for example, via a worm gear. The lift 240A may be coupled with lift 240C such as, for example, via a worm gear. The lift 240C may be coupled with lift 240D such as, for example, via a worm gear. The lift 240D may be coupled with lift 240B such as, for example, via a worm gear. The lift 240B may be coupled with lift 240F such as, for example, via a worm gear.

In this example, the lifts 240A and 240B are arranged on opposites sides of the activity deck 230, the lifts 240F and 240D are arranged on opposites sides of the activity deck 230, and the lifts 240C and 240E are arranged on opposites sides of the activity deck 230.

In some embodiments, each of a plurality of vertical lifting screws may be coupled with a bottom of the activity deck 230 and a corresponding one of the plurality of lifts 240. Each of a plurality of vertical lifting screws may be threaded and/or may move vertically from the bottom 270 of the activity pool reservoir 150 to the top surface 210 of the activity pool 100. The top of each of the plurality of vertical lifting screws may be attached with the bottom of the activity deck 230 such as, for example, via an load pad that rotates relative to the vertical lifting screw. The plurality of lifts 240 may rotate each of the vertical lifting screws causing the top of the vertical lifting screw to travel upwards or downwards.

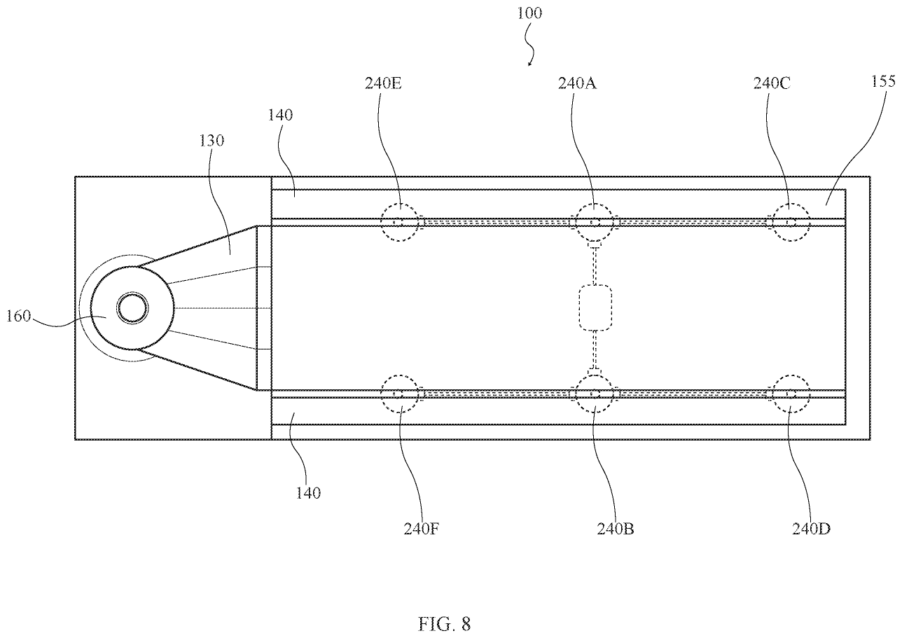

FIG. 8 is a top view of the activity pool 100 with the plurality of lifts 240 arranged in an H-configuration on the side of the activity deck 230 according to some embodiments. In the H-configuration, the motor 605 may be coupled with lift 240A and 240B of the plurality of lifts 240 such as, for example, via a worm gear. The lift 240A may be coupled with lift 240C and 240E such as, for example, via two different worm gears. The lift 240B may be coupled with lift 240D and 240F such as, for example, via two different worm gears. In this example, the lifts 240A and 240B are arranged on opposites sides of the activity deck 230, the lifts 240DF and 240B are arranged on opposites sides of the activity deck 230, and the lifts 240C and 240E are arranged on opposites sides of the activity deck 230.

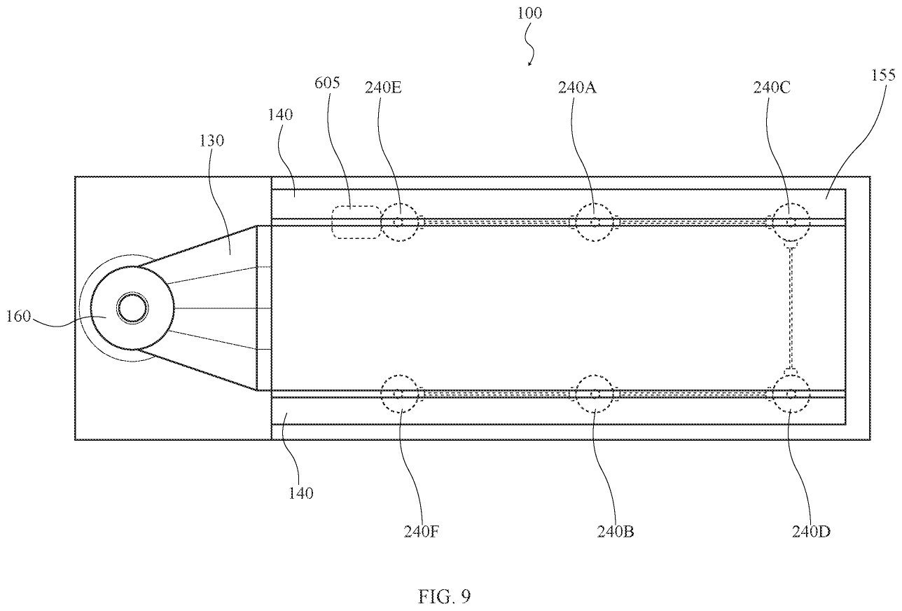

FIG. 9 is a top view of the activity pool 100 with the plurality of lifts 240 arranged in a U-configuration on the side of the activity deck 230 according to some embodiments. In the U-configuration, the motor 605 may be coupled with lift 240E of the plurality of lifts 240 such as, for example, via a worm gear. The lift 240E may be coupled with lift 240A such as, for example, via a worm gear. The lift 240A may be coupled with lift 240C such as, for example, via a worm gear. The lift 240C may be coupled with lift 240D such as, for example, via a worm gear. The lift 240D may be coupled with lift 240B such as, for example, via a worm gear. The lift 240B may be coupled with lift 240F such as, for example, via a worm gear.

In this example, the lifts 240A and 240B are arranged on opposites sides of the activity deck 230, the lifts 240DF and 240B are arranged on opposites sides of the activity deck 230, and the lifts 240C and 240E are arranged on opposites sides of the activity deck 230.

In some embodiments, each of a plurality of vertical lifting screws may be coupled with a side of the activity deck 230 and a corresponding one of the plurality of lifts 240. Each of a plurality of vertical lifting screws may be threaded and/or may extend from the bottom 270 of the activity pool reservoir 150 to the top surface 210 of the activity pool 100. Each of the plurality of vertical lifting screws may be attached with a side of the activity deck 230 via a threaded attachment mechanism. The plurality of lifts 240 may rotate each of the vertical lifting screws causing the threaded attachment mechanism to travel upwards or downwards.

In some embodiments, a sensor may determine the vertical height of the activity deck 230. The sensor, for example, may be disposed within the plurality of screw jack system and may measure rotations corresponding to an activity deck height. The sensor, for example, may be disposed within the activity deck and measures vertical distance relative to the side of the pool or the bottom 270 of the activity pool reservoir 150 or the top surface 210 of the activity pool 100. The sensor may send a signal to a controller indicating the height of the activity deck 230. The controller, for example, may adjust the speed of water flow produced by the axial flow pump 160 based on the height of the activity deck.

For example, when the activity deck 230 is set to a height configured for surfing (e.g., as shown in FIG. 6), the speed of the axial flow pump may increase with an increased depth of the activity deck 230. The options of the different configurations may allow the user to customize the height of the activity deck 230 and speed of water produced by the axial flow pump 160 depending on the specific type of activity they choose.

Although six lifts are shown in some of the figures and described above, any number of lifts may be used without limitation. Moreover, these lifts may be arranged in any manner and in any configuration without limitation.

The lifts shown in some of the figures and described above, may include any type of lift may be used such as, for example, screw jacks, scissor lifts, hydraulic lifts, and/or cable and pulleys. Any other type of lift may be used.

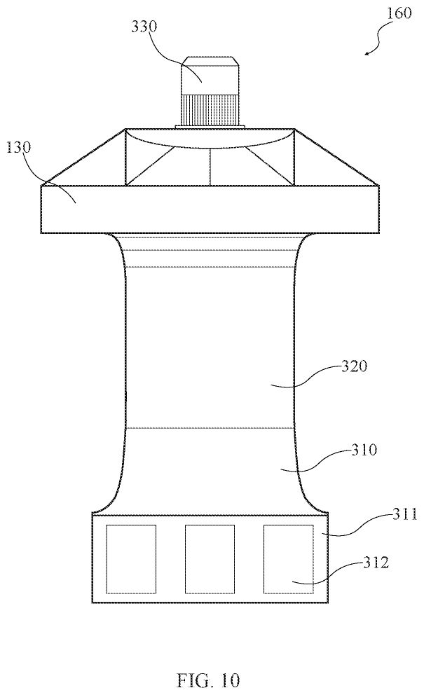

FIG. 10 is a side view of an axial flow pump 160 according to some embodiments. The axial flow pump 160 may include an axial housing that includes a water flow channel 320, a nozzle 130, a bell end 310, a bottom portion 311, and a apertures 312. The bell end 310, for example, may be located near the bottom of the axial flow pump housing. The axial flow pump housing, for example, may include a plurality of apertures 312 through which water may be pulled from the water reservoir 110 and may be pumped out the nozzle 130. These apertures, 312 for example, may be found within the bottom portion 311 and/or the bell end 310.

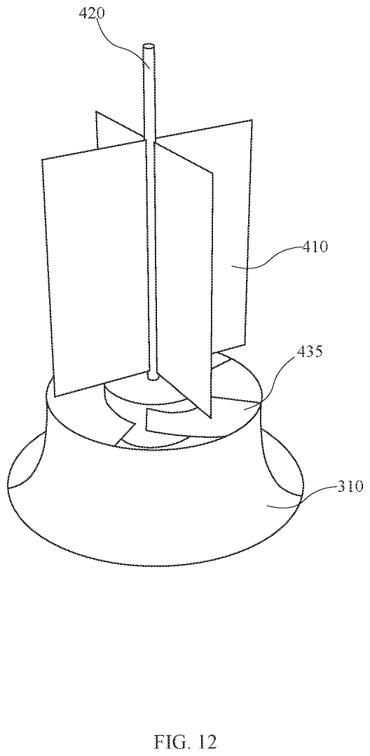

In some embodiments, the axial flow pump housing can be shaped with a bell end 310. The bell end 310 may be shaped to improve water flow into the axial flow pump housing. For example, the bell end 310 may improve uniformity of the water as water enters the axial flow pump housing from the water reservoir 110. The axial flow pump housing may also include guide vanes 410 as shown in FIG. 12. In some embodiments, the guide vanes 410 may extend along an axis of the axial flow pump housing that is generally in the path of the water when the axial flow pump is in operation. The guide vanes 410, for example, may include any number of vertical components. The guide vanes 410, for example, may include between 3 and 6 vertical components. The guide vanes 410, for example, may be coupled to an inner surface of an wall of the axial flow pump housing. The guide vanes 410, as another example, may not be coupled to the inner surface of the wall of the axial flow pump housing. The guide vanes 410, for example, may interact with an element of the inner surface of the out wall of the axial flow pump housing such that the guide vanes are restricted from rotating.

In some embodiments, the bell end 310 may be elevated from a floor of the water reservoir 110 by one or more supports or the bottom portion 311. The one or more supports may couple the axial flow pump housing to the water reservoir 110 via horizontal components and/or vertical components. Additionally or alternatively, the axial flow pump housing may be mounted to a cap of the water reservoir 110 (e.g., via the axial flow pump housing) and/or suspended above the floor of the water reservoir 110.

In some embodiments, the bell end 310 may have generally smooth curve along an edge of its cross section. In some embodiments, the bell end 310 may be implemented with any shape that narrows along an axis that generally follow the flow of water through the axial flow pump housing. In some embodiments, water may enter the bell end 310 from all 360 of the surface of the bell end 310. This could possibly help reduce vortices and turbulence in the water. The bell end 310 may be shaped like a bell and/or may have a diameter that is larger than the diameter of the water flow channel 320. In some embodiments, the bell end 310 may include grooves on the inside of the bell end 310, which may possibly reduce the rotational influence of the axial flow pump.

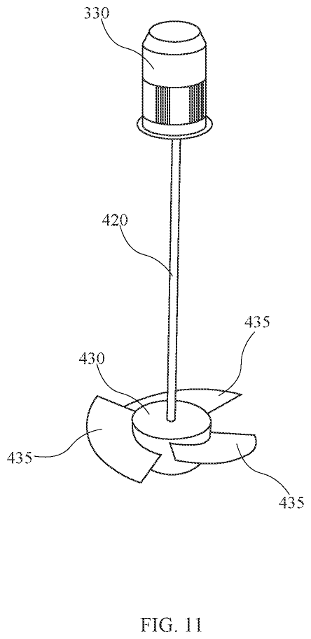

FIG. 11 is an illustration of an example axial flow pump motor 330 and impeller 430 according to some embodiments. In some embodiments, the axial flow pump motor 330 may be coupled with the impeller 430 via a drive shaft 420. In some embodiments, the axial flow pump may include a shaft seal to maintain a seal between the axial flow pump motor 330 (e.g., at the drive shaft 420) and a surface of the axial flow pump housing. The axial flow pump motor 330 may also include one or more reduction gears. The one or more reduction gears may be used to adjust a rotation rate of the drive shaft 420 and impeller 430.

The axial flow pump motor 330 may be configurable for operation at multiple speeds, which may be characterized by a rotation speed of the impeller 430 such as, for example, a volume per second of water that is driven through the intake, or a linear speed of water as it the axial flow pump propels the water through a portion of the axial flow pump housing, nozzle 130, or water flow channel 320.

The axial flow pump motor 330 may be a combustion engine or an electrical engine. In some implementations, the axial flow pump motor 330 may be powered via a connection to a battery, which may in turn be charged via a renewable power supply such as a solar panel. The axial flow pump motor 330 may be positioned above an upper surface of the axial flow pump housing and/or above the water surface 220.

In some embodiments, the axial flow pump motor 330 may be positioned to the side of the axial flow pump housing.

The drive shaft 420 may extend along a path of the water flow when the axial flow pump is in operation. The drive shaft 420 may extend along a path of the water flow through one or more of the plurality of portions.

The impeller 430 may be attached to the drive shaft 420, which may rotate to spin the various blades 435 of the impeller 430. The drive shaft 420 may extend from a hub of the impeller 430, through the intake and to the axial flow pump motor 330. In some embodiments, the drive shaft 420 may extend past a bulkhead at an end of axial flow pump housing, through a shaft seal, and to the axial flow pump motor 330. In some embodiments, the blades 435 of the impeller 430 may be attached to an impeller hub and extend outwardly toward an inside wall of the axial flow pump housing. The blades 435 may be shaped so that the impeller provides thrust on the water when rotated to draw water further into the axial flow pump housing. For example, the impeller may direct water along a path that is generally parallel with the drive shaft 420.

In some embodiments, the diameter of the impeller 430 may be about the same diameter as an inner diameter of the axial flow pump housing and/or an inner diameter of the water flow channel 320 and/or an inner diameter of the axial flow pump housing. In some embodiments, the impeller 430 may be shaped to create a force on the water that draws it at least partially in a vertical direction and further into the axial flow pump housing. In some embodiments, the impeller 430 may draw the water in a horizontal direction or another direction that influences the water to be drawn farther into the axial flow pump housing. The impeller 430 may, for example, have a bell-shaped dome on the bottom side and/or directly over the hub to help draw the water more efficiently around the impeller 430 and into the axial flow pump housing. The impeller 430 may, for example, be flat or have another shape that may help draw water around the hub and into the axial flow pump housing.

In some implementations, the axial flow pump 160 may be coupled with a controller that can control the speed of the axial flow pump motor 330. The controller may control power or to the axial flow pump such that it achieves the requested operational speed. For example, the controller may receive an input requesting a flow rate of 20 cubic feet per second. The controller may increase or decrease power to the axial flow pump until the controller receives input (e.g., from a sensor within the wave flow apparatus). Alternatively, the controller may receive an input to increase or decrease a flow rate, responsive to which the controller correspondingly increases or decreases power to the axial flow pump.

FIG. 12 is an illustration of a guide vane structure 410 that may be disposed within the axial flow pump housing according to some embodiments. In some embodiments, the guide vane structure may be in positional context with an optional bell end 310, the impeller 430, and/or the drive shaft 420. In some embodiments, the guide vane structure 410 may include one or more guide vanes, which may, for example, reduce a rotational flow of water that is generated by the rotating the impeller 430. The guide vane structure 410, for example, may comprise a rust-resistant material, such as a polymer coating over a metallic material. The guide vane structure 410, for example, may be restricted from rotating by being coupled to an interior surface of the axial flow pump housing. The guide vane structure 410, for example, may be restricting from rotating by interacting with a structure of the interior surface of the axial flow pump housing that extends inwardly toward the drive shaft 420.

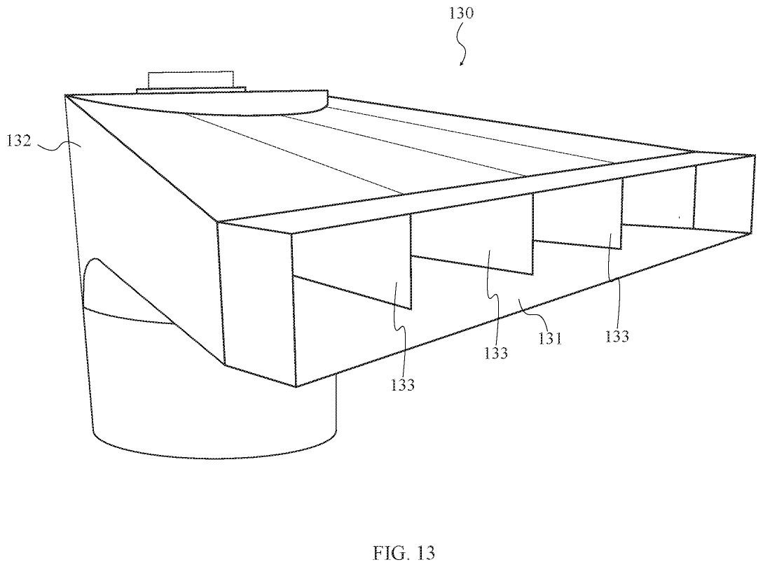

FIG. 13 is an illustration of an outlet nozzle 130 according to some embodiments. In some embodiments, the proximal cross-sectional area 132 of the outlet nozzle 130 proximal to the water flow channel 320 and/or the motor 330 may be larger than the distal cross-sectional area 131 located distally relative to the water flow channel 320 and/or the motor 330 and/or nearer the activity pool reservoir 150.

In some embodiments, the proximal cross-sectional area 132 of the outlet nozzle 130 proximal to the water flow channel 320 and/or the motor 330 may be smaller than the distal cross-sectional area 131 located distally relative to the water flow channel 320 and/or the motor 330 and/or nearer the activity pool reservoir 150.

In some embodiments, the proximal cross-sectional area 132 of the outlet nozzle 130 proximal to the water flow channel 320 and/or the motor 330 may be the same as the distal cross-sectional area 131 located distally relative to the water flow channel 320 and/or the motor 330 and/or nearer the activity pool reservoir 150.

In some embodiments, the outlet nozzle 130 may include spreading or converging guides 133 interior to the outer surface of the nozzle 130. In some embodiments, the spreading or converging guides 133 may be parallel to an outer surface of the nozzle 130. In some embodiments, the spreading or converging guides 133 may not be parallel to an outer surface of the nozzle 130 such as, for example, off axis with respect to the water flow. In some embodiments, the converging guides 133 may be removed or not included. In some embodiments, the converging guides 133 may be parallel to the flow of water. In some embodiments, the converging guides may be off-axis to the direction of the flow of water.

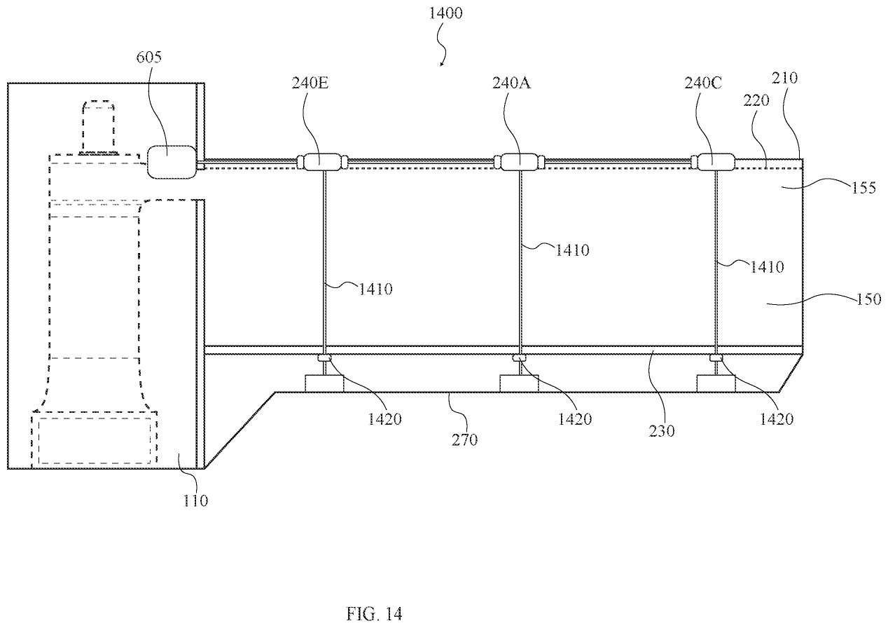

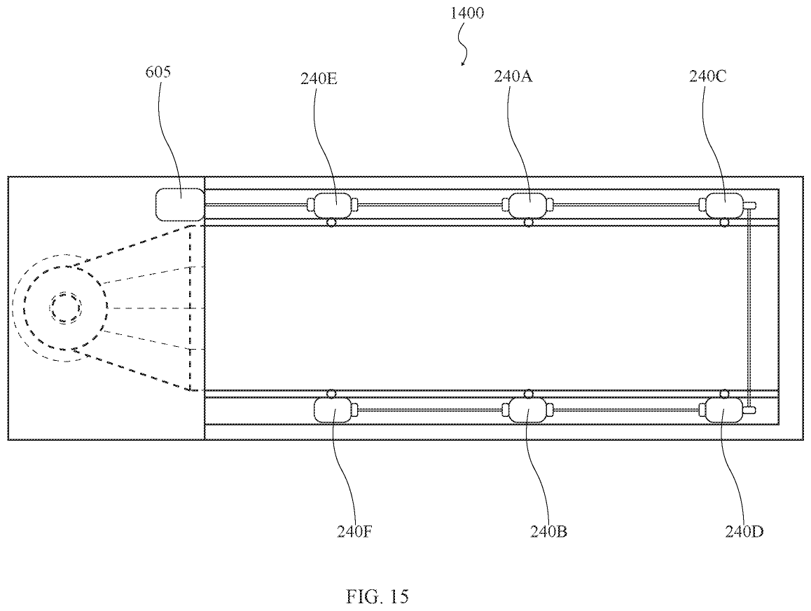

FIG. 14 is a side view and FIG. 15 is a top view illustration of an activity pool 1400 along a slice through the activity pool 1400 according to some embodiments. The motor 605, the lifts 240, and/or the worm gears 1410 are disposed above the water line 220. The lifts 240, for example, may comprise jack screws. Each lift 240 may rotate a worm gear 1410 that is fixed between the lift 240 and the bottom 270 of the activity pool reservoir 150. Each worm gear, for example, may be engaged with a traveling nut 1420 that is affixed to the activity deck 230. The worm gear 1410 may have threads that extend the length of the worm gear 1410. The traveling nut 1420 may include threads that can be threaded onto the threads of the worm gear 1410. When the worm gear 1410 is rotated one direction, the traveling nut 1420 is moved upward. When the worm gear 1410 is rotated the opposite directions, the traveling nut 1420 is moved downward. The activity deck 230 may be moved upwardly and downwardly as the traveling nut 1420 is moved upward and downward.

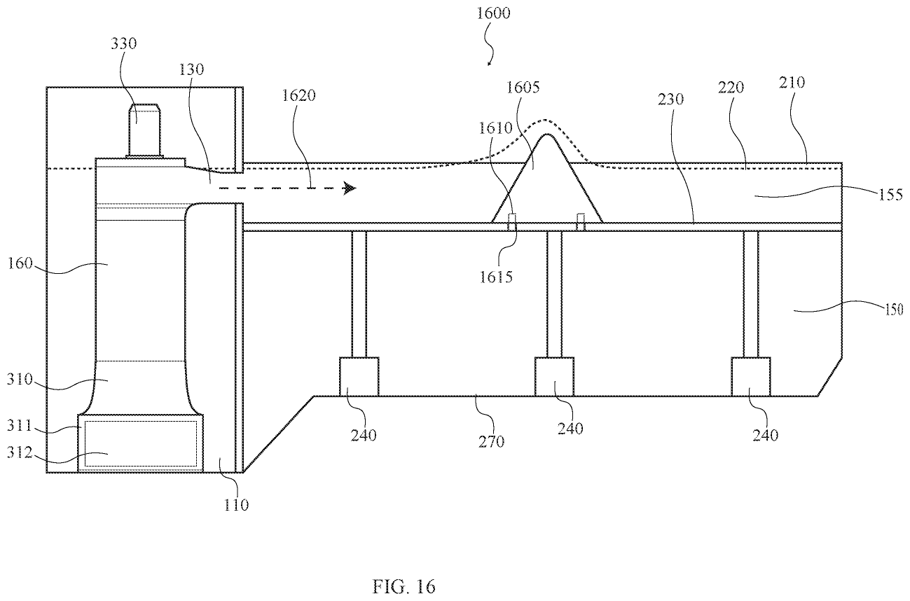

FIG. 16 is a side view illustration of an activity pool 1600 in a sport pool configuration or a surf pool configuration according to some embodiments. In this configuration, the activity pool 1600 includes a triangular shaped accessory 1605 coupled with activity deck 230. For example, the triangular shaped accessory 1605 may include bolts 1610 that can be screwed into the nut sleeves 1615. Water is propelled out of the axial flow pump may engage with the triangular shaped accessory 1605 to create a wave that can be surfed. The triangular shaped accessory 1605 may include any size or shape.

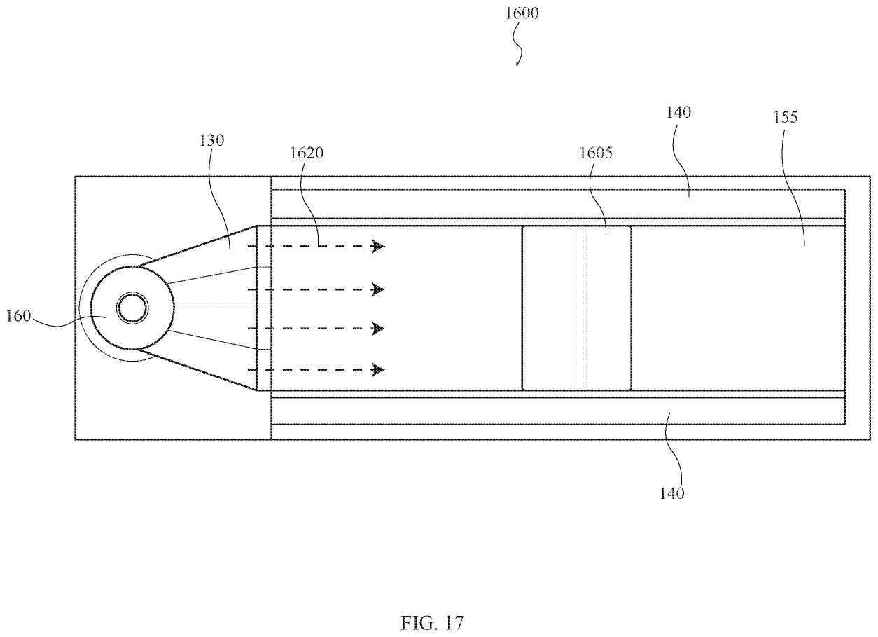

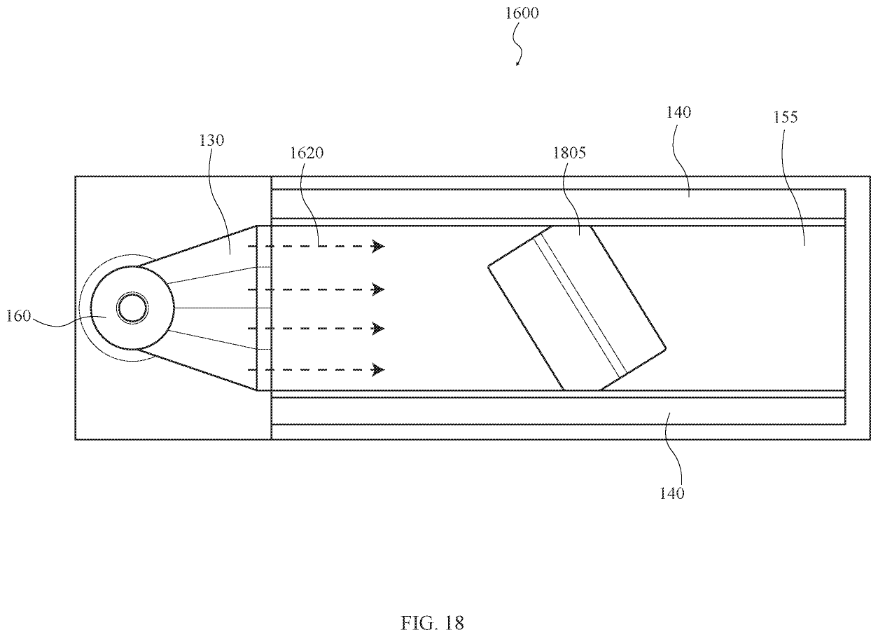

FIG. 17 is a top view illustration of the activity pool 1600 according to some embodiments. In this example, the triangular shaped accessory 1705 is substantially perpendicular with the water flow 1620 direction. FIG. 18 is a top view illustration of the activity pool 1600 according to some embodiments. In this example, the activity pool 1600 includes an angled triangular shaped accessory 1805 is off axis with respect to the direction of the water flow 1620. The angled triangular shaped accessory 1805, for example, may be positioned between about 40 and 60 degrees with respect to the direction of the water flow 1620.

FIG. 19 is a side view illustration of an activity pool 1900 in a sport pool configuration or a swim pool configuration according to some embodiments. In this configuration, the activity pool 1900 includes a fin shaped accessory 1905 coupled with activity deck 230. For example, the fin shaped accessory 1905 may include bolts 1610 that can be screwed into the nut sleeves 1615. Water is propelled out of the axial flow pump may provide a current that can be swam against by a user. The fin shaped accessory 1905 may provide a backstop for the user.

In some embodiments, an activity pool may include a reservoir configured for storing water when the activity pool is not in use; an intake in communication with the reservoir, the intake housing one or more elements of an axial flow pump; a nozzle in communication with the intake; a channel in communication with the nozzle; and a water return in communication with the channel and allows water to return to the reservoir from the channel. In some embodiments, when the axial flow pump is in operation, water is drawn from the reservoir into the intake, through the nozzle, through the channel, through the water return, and back to the reservoir.

In some embodiments, the axial flow pump may include a motor positioned outside of the intake and the reservoir. In some embodiments, axial flow pump may include an impeller positioned in one of the intake and the reservoir. In some embodiments, the impeller may be coupled to the motor via a shaft such that when the motor is in operation, the shaft rotates the impeller.

In some embodiments, one or more of a height and a width of a portion of the nozzle proximate to the intake is greater than a corresponding one or more of a height and a width of another portion of the nozzle distal from the intake.

Unless otherwise specified, the term “substantially” means within 5% or 10% of the value referred to or within manufacturing tolerances. Unless otherwise specified, the term “about” means within 5% or 10% of the value referred to or within manufacturing tolerances.

The conjunction “or” is inclusive.

Numerous specific details are set forth to provide a thorough understanding of the claimed subject matter. However, those skilled in the art will understand that the claimed subject matter may be practiced without these specific details. In other instances, methods, apparatuses or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained in software to be used in programming or configuring a computing device.

Embodiments of the methods disclosed may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

That which is claimed:

1. An activity pool comprising:
a pool comprising a top opening and a depth;
an activity deck disposed within the pool, the activity deck is moveable in a vertical direction between at least two of the following configurations:
a full pool configuration where the activity deck is positioned at a first level, the first level being lowest vertical position;
a sport pool configuration where the activity deck is positioned below the top opening of the pool at a second level, the second level being above the first level;
a kiddie pool configuration where the activity deck is positioned below the top opening of the pool at a third level, the third level being above the first level and the second level; and
an activity court configuration where the top surface of the activity deck is coplanar with or above the top surface of the pool; and
a plurality of lifts coupled with the activity deck, the plurality of lifts move the activity deck between the configurations.

2. The activity pool according to claim 1, wherein the activity deck comprises a composite material coupled with a metallic frame.

3. The activity pool according to claim 1, wherein the second level is between 1 feet and 3 feet below the top surface of the pool.

4. The activity pool according to claim 1, wherein the third level is between 4 inches and 3 feet below the top surface of the pool.

5. The activity pool according to claim 1, wherein the plurality of lifts comprise at least one lift selected from the group consisting of screw jacks, scissor lifts, hydraulic lifts, and cable and pulleys.

6. The activity pool according to claim 1, wherein the plurality of lifts comprise a plurality of screw jacks.

7. The activity pool according to claim 6, wherein the plurality of screw jacks are coupled with a one or more motor that engages each of the plurality of screw jacks to raise or lower the activity deck.

8. The activity pool according to claim 6, wherein the plurality of screw jacks include a worm gear.

9. The activity pool according to claim 6, wherein the plurality of screw jacks are disposed above a water line when the pool is filled with water.

10. The activity pool according to claim 6, wherein the plurality of screw jacks are arranged in an H-shaped configuration or a U-shaped configuration.

11. The activity pool according to claim 1, further comprising an accessory mechanism removably coupled with a top surface of the activity deck.

12. An activity pool comprising:
a pool volume having a top opening and a depth; and
an activity deck disposed within the pool volume, the activity deck is moveable in a vertical direction between at least two configurations, the activity deck comprises a composite material; and
a plurality of screw jacks coupled with the activity deck, the plurality of screw jacks move the activity deck between the at least two configurations, the plurality of screw jacks being coupled together with a one or more motor that engages each of the plurality of screw jacks via one or more worm gears.

13. The activity pool according to claim 12, wherein the plurality of screw jacks are coupled with a bottom of the activity deck.

14. The activity pool according to claim 12, wherein the at least two configurations are selected from the group consisting of:
a full pool configuration where the activity deck is positioned at a first level, the first level being lowest vertical position;
a sport pool configuration where the activity deck is positioned below the top opening of the pool at a second level, the second level being above the first level;
a kiddie pool configuration where the activity deck is positioned below the top opening of the pool at a third level, the third level being above the first level and the second level; and
an activity court configuration where the top surface of the activity deck is coplanar with or above the top surface of the pool.

15. The activity pool according to claim 12, wherein the plurality of screw jacks are disposed above a water line when the pool is filled with water.

16. The activity pool according to claim 12, wherein the plurality of screw jacks are arranged in an H-shaped configuration or a U-shaped configuration.

17. The activity pool according to claim 12, wherein the activity deck comprises:
a metallic frame; and
a composite top surface.

17. The activity pool according to claim 12, wherein the activity deck includes a plurality of nut sleeves disposed within the activity deck.
